(19) United States
(12) Patent Application Publication
(10) Pub. No.: US 2003/0098085 A1
(43) Pub. Date: May 29, 2003

(54) Automotive fuel hose

(75) Inventors: Hiroaki Ito, Kasugai-shi (JP); Kazutaka Katayama, Kornaki-shi (JP); Junichiro Suzuki, Kasugai-shi (JP)

Correspondence Address: ARMSTRONG,WESTERMAN & HATTORI, LLP, 1725 K STREET, NW, SUITE 1000, WASHINGTON, DC, 20006, US

(73) Assignee: TOKAI RUBBER INDUSTRIES, LTD., Komaki-shi (JP)

(21) Appl. No.: 10/280,029

(22) Filed: Oct. 25, 2002

(30) Foreign Application Priority Data
Oct. 25, 2001 (JP) JP2001-328090

(51) Int. Cl. F16L 11/00

(52) U.S. Cl. 138/137; 138/141; 138/140

(57) ABSTRACT

An automotive fuel hose which satisfies low permeability requirements in conformity with stringent regulations against vapor emission of hydrocarbons and alcohol-containing hydrocarbons, and is less permeable to hydrogen and excellent in sour gasoline resistance and inter-layer adhesion. The automotive fuel hose comprises: an inner layer (1) comprising one of a fluororesin and a polyolefin resin; and a low permeability layer (2) comprising a polybutylene naphthalate; the inner layer (1) having a plasma-treated outer peripheral surface (1a); the low permeability layer (2) being provided on the plasma-treated surface (1a) of the inner layer (1).

### BACKGROUND OF THE INVENTION

1. Field of the Invention

The present invention relates to an automotive fuel hose for transportation of an automotive fuel (gasoline, alcohol-containing gasoline, alcohol, hydrogen, light oil, dimethyl ether or the like).

2. Description of the Art

With growing worldwide awareness of environmental issues, the control of the amount of hydrocarbon vapor emission from an automotive fuel hose has been enhanced. Particularly in the united States, stringent regulations against the vapor emission have recently come into effect. To cope with the hydrocarbon vapor emission control in this situation, multi-layer hoses have been proposed which include a low permeability layer such as composed of a fluororesin, a polyester resin or a polyphenylene sulfide (PPS) resin. A multi-layer hose including a fluororesin layer has a relatively low permeability. To satisfy a stricter low-permeability requirement, the thickness of the fluororesin layer should be increased, resulting in correspondingly higher costs. On the other hand, the polyester resin and the PPS resin are more excellent in permeation resistance than the fluororesin and, therefore, a layer composed of the polyester resin or the PPS resin has a satisfactory permeation resistance even if having a relatively small thickness The polyester resin layer and the PPS resin layer are advantageous in terms of costs, but have difficulty in lamination because of their poorer adhesion.

To solve the aforesaid drawback, the following hoses (1) to (4) have been proposed.

As proposed in Japanese Patent No. 3126275, a hose (1) has a five-layer structure consisting of a fluororesin layer, an adhesive resin layer, a polybutylene naphthalate layer, an adhesive resin layer and a thermoplastic resin layer stacked in this order from the inner side thereof. A mixture of a fluorine-containing material and a crystalline polyester or a polyester elastomer blended with a compatibilizing agent is used as an adhesive resin for the adhesive resin layer.

As proposed in Japanese Patent No. 3126275, a hose (2) has a five-layer structure consisting of a polyamide resin layer, an adhesive resin layer, a polybutylene naphthalate layer, an adhesive resin layer and a thermoplastic resin layer stacked in this order from the inner side thereof. A mixture of a polyamide resin and a crystalline polyester or a polyester elastomer blended with a compatibilizing agent is used as an adhesive resin for the adhesive resin layer.

As proposed in Japanese Unexamined Patent Publications No. 5-220911 (1993) and No. 5-220912 (1993) a hose (3) has a three-layer structure consisting of a polyamnide resin layer, a polyester resin layer and a polyamide resin layer.

As proposed in Japanese Patent No. 3194053, a hose (4) has a multi-layer structure consisting of a laminate of a fluororesin layer, an adhesive resin layer, a partial aromatic polyamide layer, an adhesive resin layer and a resin layer, and a laminate of a corona-treated fluororesin layer, an adhesive layer, a partial aromatic polyamide layer, an adhesive resin layer and a resin layer.

However, the hoses (1) and (2) are disadvantageous in that adhesion between the innermost fluororesin layer or polyamide resin layer and the intermediate polybutylene naphthalate layer is very poor. If the adhesion between the inner layer and the intermediate polybutylene naphthalate layer which serves to prevent the permeation of a fuel is insufficient, the inner layer is delaminated to hang down, thereby reducing the inner space of the hose. This may result in clogging of the hose or reduction in the flow rate of the fuel. Particularly, the hose (2) which includes the polyamide resin layer as the innermost layer is inferior in sour gasoline resistance (resistance to sour gasoline resulting from oxidation of gasoline) which is an essential property required when the hose is used as a fuel hose. In the case of the hose (3), a mixture of a polyester resin and a carboxylic anhydride containing polymer or a carboxyl containing resin is used as the material for the polyester resin layer, so that adhesion between the polyester resin layer and the polyamide resin layer is excellent. However, the carboxylic anhydride containing polymer or the carboxyl containing resin deteriorates the permeability resistance of the polyester resin per se. In addition, the hose (3) which includes the polyamide resin layer as the inner layer is inferior in sour gasoline resistance as in the case of the hose (2). In the case of the hose (4), adhesion between the respective layers is poor, and the partial aromatic polyamide layer is highly permeable to the alcohol-containing gasoline. In addition, the hose (4) has a high rigidity, so that an end portion of the aromatic polyamide layer of the hose is liable to be cracked by a freeze-preventing agent.

In view of the foregoing, it is an object of the present invention to provide an automotive fuel hose which satisfies low permeability requirements in conformity with stringent regulations against vapor emission of hydrocarbons and alcohol-containing hydrocarbons, and is less permeable to hydrogen and excellent in sour gasoline resistance and inter-layer adhesion.

### SUMMARY OF THE INVENTION

In accordance with the present invention to achieve the aforesaid object, there is provided an automotive fuel hose, which comprises: an inner layer comprising one of a fluororesin and a polyolefin resin; and a low permeability layer comprising a polybutylene naphthalate; the inner layer having a plasma-treated outer peripheral surface; the low permeability layer being provided on the plasma-treated surface of the inner layer.

The inventors of the present invention conducted intensive studies to provide an automotive fuel hose which satisfies low permeability requirements in conformity with the stringent regulations against the vapor emission of hydrocarbons and alcohol-containing hydrocarbons, and is less permeable to hydrogen and excellent in sour gasoline resistance and inter-layer adhesion. As a result, it was found that, where a fluororesin or a polyolefin resin having an excellent sour gasoline resistance and a polybutylene naphthalate having a particularly excellent permeation resistance are employed as a material for an inner layer to be brought into direct contact with a fuel and as a material for a low permeability layer to be provided on the inner layer, respectively, and the outer peripheral surface of the inner layer is plasma-treated on which the low permeability layer is formed, adhesion between the inner layer and the low permeability layer can be improved. This is because the fluororesin or the polyolefin resin is modified so that hydroxyl groups are generated on the surface of the inner layer and interact with terminal carboxyl groups of the polybutylene naphthalate. Thus, the aforesaid object has been achieved to attain the present invention. Particularly, the polybutylene naphthalate has a high melting point. Therefore, the polybutylene naphthalate can be extruded at a higher temperature, so that the interaction between the hydroxyl groups and the carboxyl groups is enhanced.

Where an adhesive layer of a specific adhesive resin is provided between the inner layer and the low permeability layer, the adhesion between the inner layer and the low permeability layer is further improved.

Where the polybutylene naphthalate is-modified by terminating the terminal groups of the polybutylene naphthalate with a compound having a specific functional group such as an amino group, the adhesion between the inner layer and the low permeability layer is further improved. Where a silane compound having an amino group and an alkoxy group is employed as the compound having the specific functional group, for example, the alkoxy group of the silane compound reacts with the polybutylene naphthalate, and the amino group (functional group) of the silane compound reacts with the plasma-treated surface. Thus, the adhesion between the inner layer and the low permeability layer is further improved.

Where the inner layer includes at least one electrically conductive sublayer having a surface electrical resistance of not higher than 10⁶Ω, static electricity generated by a fuel pump can efficiently be released through the electrically conductive sublayer. Thus, an accident such as ignition of the fuel (e.g., gasoline) can effectively be prevented which may otherwise be caused by the static electricity.

### BRIEF DESCRIPTION OF THE DRAWINGS

FIG. 1 is a diagram illustrating the construction of an automotive fuel hose according to one embodiment of the present invention;

FIG. 2 is a diagram illustrating one exemplary method for producing the automotive fuel hose shown in FIG. 1; and

FIG. 3 is a diagram illustrating the construction of an automotive fuel hose according to another embodiment of the present invention.

### DESCRIPTION OF THE PREFERRED EMBODIMENTS

Embodiments of the present invention will hereinafter be described in detail.

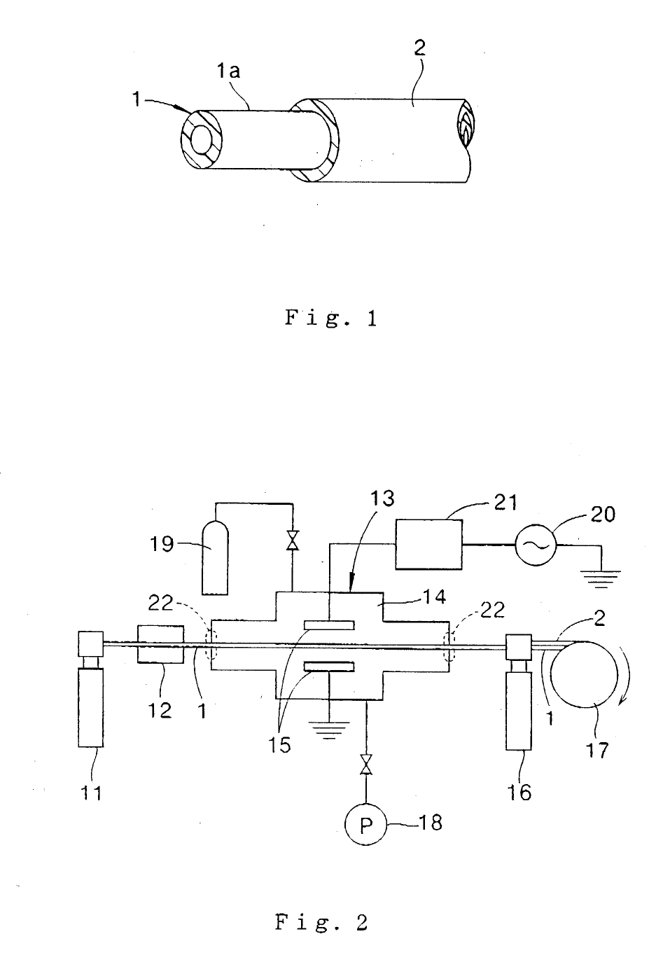

As shown in FIG. 1, an automotive fuel hose according to one embodiment of the present invention includes an inner layer 1 comprising a specific resin and having a plasma-treated outer peripheral surface 1a, and a low permeability layer 2 comprising a polybutylene naphthalate (PBN) and provided on the plasma-treated surface 1a of the inner layer 1. An outer layer (not shown) may be provided on an outer peripheral surface of the low permeability layer 2 as required.

A fluororesin or a polyolefin resin having an excellent sour gasoline resistance is employed as a material (specific resin) for the inner layer 1.

The fluororesin is not particularly limited, but examples thereof include a copolymer of ethylene and tetrafluoroethylene (ETFE), a copolymer of hexafluoropropylene and tetrafluoroethylene (FEP), a copolymer of ethylene and chlorotrifluoroethylene (ECTFE), a copolymer of vinylidene fluoride and hexafluoropropylene, a copolymer of vinylidene fluoride and chlorotrifluoroethylene, polytetrafluoroethylene (PTFE), a copolymer of tetrafluoroethylene, vinylidene fluoride, hexafluoropropylene and perfluoroalkoxyvinyl ether, and a copolymer of tetrafluoroethylene, vinylidene fluoride, hexafluoropropylene and perfluoroalkylvinyl ether. These fluororesins may be used either alone or in combination. Among these fluororesins, the ETFE are particularly preferred because of their excellent flexibility and workability.

The polyolefin resin is not particularly limited, but examples thereof include polyethylene, polypropylene, polybutene, polymethylpentene, and copolymers thereof. These polyolefin resins may be used either alone or in combination- Among these polyolefin resins, the polyethylene, the polypropylene and the polybutene are particularly preferred because of their excellent flexibility and workability.

An electrically conductive material such as carbon black, nano-carbon, metal powder or metal oxide powder is preferably blended in the aforesaid inner layer material, so that static electricity generated by a fuel pump is released through the inner layer to the outside of the hose for prevention of ignition of a fuel (e.g., gasoline) Where the inner layer is thus imparted with an electrical conductivity, the inner layer (electrically conductive layer) preferably has a surface electric resistance of not higher than 10⁶Ω, particularly preferably 10 to 10⁵Ω. The proportion of the electrically conductive material is preferably determined so that the surface electrical resistance falls within the aforesaid range.

The method for plasma-treating the outer peripheral surface 1a of the inner layer 1 is not particularly limited. Exemplary methods for the plasma treatment include a reduced pressure plasma treatment in which a discharge gas is introduced into a chamber kept at a reduced pressure and the layer is exposed in a plasma atmosphere generated by application of a radio wave, and a normal pressure plasma treatment in which a discharge gas is introduced into a chamber kept at a normal pressure and the layer is exposed in a plasma atmosphere generated by application of a radio wave. The reduced pressure plasma treatment is particularly preferred because the layer can uniformly be subjected to the plasma treatment. An Ar-containing gas is preferably used as the discharge gas. Examples of the Ar-containing gas include Ar gas, a mixture of Ar gas and N₂ gas, a mixture of Ar gas and H₂ gas, and a mixture of Ar gas and O₂ gas. Where any of the gas mixtures is employed, the Ar gas is preferably contained in the gas mixture in a proportion of not smaller than 50 vol %.

The low permeability layer 2 provided on the plasma-treated surface 1a is composed of a polybutylene naphthalate (PBN) which has an excellent permeation resistance. The PBN is obtained by condensation of tetramethylene glycol and 2,6-naphthalenedicarboxylic acid or its ester. The PBN may be a thermoplastic ester elastomer (TPEE) imparted with flexibility by copolymerizing a PBN with an ether segment, as long as the TPEE satisfies the permeation resistance requirement For improvement of heat resistance and shock resistance, the PBN may be polymerized with a bifunctional compound or a trifunctional compound.

The PBN is preferably a modified PBN having a terminal carboxyl group terminated with at least one compound selected from the group consisting of a diamine compound, an amino-containing compound, an epoxy-containing compound and a double-bond-containing silane compound for improvement of the adhesion. The modified PBN has a permeation resistance comparable to that of the non-modified PBN.

Examples of the diamine compound include hexamethylenediamine, dodecamethylenediamine, m-phenylenediamine, tolylene-2,4-diamine, tolylene-2,6-diamine, tolylene-3,4-diamine, tolylene-3,5-diamine, m-xylylenediamine, p-xylylenediamine, N,N′-cinnamylidene-1,6-hexanediamine, 4,4′-diaminodiphenylmethane (methylenedianiline), 4,4′-diaminodiphenyl ether and 4,4′-diaminodiphenyl sulfone. These diamine compounds may be used either alone or in combination. Among these diamine compounds, hexamethylenediamine and m-xylylenediamine are particularly preferred because of their excellent adhesion.

Examples of the amino-containing compound include N-(2-aminoethyl)-3-aminopropylmethyldimethoxysilane, N-(2-aminoethyl)-3-aminopropyltrimethoxysilane, N-(2-aminoethyl)-3-aminopropyltriethoxysilane, 3-aminopropyltrimethoxysilane and 3-aminopropyltriethoxysilane in a solution form. These amino-containing compounds may be used either alone or in combination. Among these amino-containing compounds, N-(2-aminoethyl)-3-aminopropyltrimethoxysilane and N-(2-aminoethyl)-3-aminopropyltriethoxysilane are particularly preferred because of their excellent adhesion.

Examples of the epoxy-containing compound include 3-glycidoxypropyltrimethoxysilane, 3-glycidoxypropyltriethoxysilane, 3-glycidoxypropylmethyldimethoxysilane, 3-glycidoxypropylmethyldiethoxysilane and 2-(3,4-epoxycyclohexyl)-ethyltrimethoxysilane. These epoxy-containing compounds may be used either alone or in combination. Among these epoxy-containing compounds, 3-glycidoxypropyltrimethoxysilane is particularly preferred because of its excellent adhesion.

Examples of the double-bond-containing silane compound include vinyltrimethoxysilane, vinyltriethoxysilane, vinyl-tris-(2-methoxyethoxy)-silane, 3-methacryloxypropylmethyldimethoxysilane, 3-methacryloxypropylmethyldiethoxysilane, 3-methacryloxypropyltrimethoxysilane, 3-methacryloxypropyltriet.hoxysilane, N-(vinylbenzyl)-2-aminoethyl-3-aminopropyl-trimethoxysilane hydrochloride and vinyltriacetoxysilane in a solution form. These silane compounds may be used either alone or in combination. Among these silane compounds, vinyltriethoxysilane is particularly preferred because of its excellent adhesion.

The termination of the terminal carboxyl group of the PBN is achieved, for example, by melt-mixing the PBN and the compound having any of the aforesaid functional groups, or by bringing particles of a melt of the PBN into contact with a solution of the compound having any of the aforesaid functional groups. The particles of the PBN preferably have an average particle diameter of 20 to 500 μm.

The PBN preferably has a viscosity of 70 to 260 cm³/g, particularly preferably 80 to 240 cm³/g, in consideration of a balance between extrudability and resistances to shock, heat and hydrolysis. The viscosity is determined at 35° C. in conformity with ASTM D 2857 by employing a solution obtained by dissolving the PBN in a concentration of 0.005 g/cm³ in a solvent mixture of phenol and tetrachloroethane.

The material for the outer layer is not particularly limited, but examples thereof include polyamide resins such as polyamide 6 (PA6), polyamide 66 (PA66), polyamide 612 (PA612), polyamide 11 (PA11), polyamide 912 (PA912) and polyamide 12 (PA12), a thermoplastic ester elastomer (TPEE), a thermoplastic polyamide elastomer (TPAE), a thermoplastic polyolefin elastomer (TPO) and a thermoplastic polystyrene elastomer (TPS).

The inventive automotive fuel hose shown in FIG. 1 is produced by a process as shown in FIG. 2. For preparation of an inner layer material, the electrically conductive material, as required, is blended in the fluororesin or the polyolefin resin. By means of an extruder 11, the inner layer material is extruded into a sizing water vessel 12 at a reduced pressure for formation of an inner layer 1 having a predetermined size. Then, the inner layer 1 is introduced into a reaction chamber 14 of a reduced pressure plasma treatment device 13, and plasma-treated in a plasma treatment zone defined between electrodes 15. Subsequently, the PBN is extruded on a plasma-treated surface of the inner layer I by means of an extruder 16 for formation of a low permeability layer 2. At this time, the extrusion temperature is preferably 250 to 280° C. The resulting product is wound up by means of a winder 17. Thus, the intended fuel hose (see FIG. 1) is produced. After the formation of the low permeability layer 2, an outer layer is formed, as required, on the low permeability layer 2 by means of an extruder.

After the inner pressure of the reaction chamber 14 is reduced--by means of a vacuum pump 18 for stably generating a plasma, a discharge gas (Ar-containing gas) is introduced into the reaction chamber 14 by a gas feeding device 19, and the reaction chamber 14 is kept at a reduced pressure (typically at 0.6 to 1×10³ Pa). For the plasma treatment, a matched high-frequency and high-output electric current is applied across the electrodes 15 from a high frequency power source 20 for a predetermined period by means of a matching box 21 to cause electric discharge between the electrodes 15. Thus, the discharge gas is dissociated to produce a plasma atmosphere. At this time, the frequency is typically 0.1 to 1000 MHz, preferably 1 to 100 MHz. The output of the high frequency power source 20 is typically 2 to 400W, preferably 5 to 300W. The treatment period is properly determined depending on the type of the material (the fluororesin or the polyolefin resin) for the inner layer and the size of the inner layer, but typically 1 to 180 seconds, preferably 2 to 60 seconds. The plasma treatment is preferably a glow discharge plasma treatment in an Ar-containing gas atmosphere. The glow discharge plasma treatment is more advantageous in that a high level of performance is not required for the reduced pressure plasma treatment device 13 without strict requirements for reduced pressure conditions. Although the electrodes 15 for the plasma treatment are illustrated as parallel planar electrodes, induction coil electrodes may be provided outside the reaction vessel 14 instead of the parallel planar electrodes.

The plasma treatment is preferably performed at a pressure lower than the atmospheric pressure. If a seal portion 22 of the reduced pressure plasma treatment device 13 has a poor sealing property, it is difficult to control the inner pressure of the reduced pressure plasma treatment device 13 at a predetermined reduced pressure so as not to stable generate a plasma. Therefore, the seal portion 22 is preferably composed of an elastomer. The elastomer preferably has a hardness of 45 to 80 (as measured in conformity with Japanese Industrial Standard (JIS) A). The type of the elastomer is not particularly limited, but a silicone rubber or an acrylonitrile- butadiene copolymer rubber (NBR) is advantageously employed. In the present invention, the inner layer may further be treated with water and an aqueous solution of a silane coupling agent as required after the plasma treatment.

Although the inner layer 1 is formed in the sizing water vessel 12 without the use of a mandrel as shown in FIG. 2, the mandrel may be employed without the use of the sizing water vessel 12. That is, the inner layer 1 is extruded around the mandrel.

The inventive automotive fuel hose thus produced preferably has an inner diameter of 4 to 40 mm, particularly preferably 6 to 30 mm, and an outer diameter of 6 to 44 mm, particularly preferably 8 to 32 mm. The inner layer 1 preferably has a thickness of 0.02 to 1.0 mm, particularly preferably 0.05 to 0.6 mm. The low permeability layer 2 preferably has a thickness of 0.02 to 0.8 mm, particularly preferably 0.05 to 0.6 mm.

In the present invention, the structure of the inner layer 1 is not limited to a single-layer structure as shown in FIG. 1, but may be a multi-layer structure consisting of two or more sublayers. Likewise, the outer layer may have a multi-layer structure consisting of two or more sublayers. For example, the inner layer 1 may have a double-layer structure consisting of an electrically conductive inner sublayer and an electrically non-conductive outer sublayer. The formation of the inner layer having the double-layer structure is achieved by simultaneously extruding an electrically conductive resin and an electrically non-conductive resin from separate extruders and combining the resulting sublayers by a die. For formation of the outer layer having a double-layer structure, the low permeability layer is formed on the outer periphery of the inner layer in the aforesaid manner, and the resulting product is employed as a mandrel. That is, first and second resins for the outer layer are simultaneously extruded on the outer periphery of the low permeability layer serving as the mandrel, and the resulting sublayers are combined around the mandrel. Alternatively, the low permeability layer material and the first and second resins for the outer layer may simultaneously be extruded on the outer periphery of the inner layer from separate extruders for the formation of the low permeability layer and the outer layer.

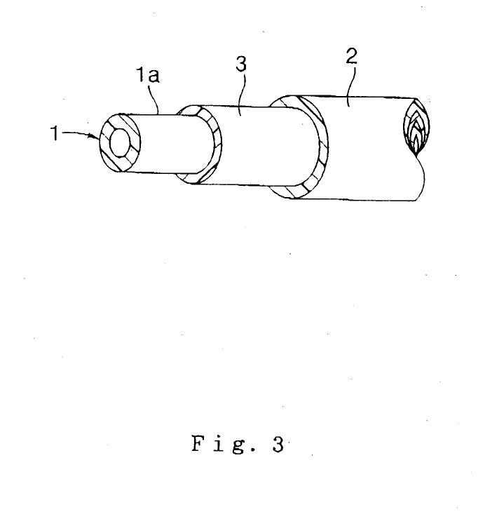

An automotive fuel hose according to another embodiment of the present invention has substantially the same construction as the aforesaid automotive fuel hose, but includes an adhesive layer 3 of a specific adhesive resin provided between the inner layer 1 and the low permeability layer 2 as shown in FIG. 3.

The specific adhesive resin contains at least one of an amino group and an epoxy group. Examples of the adhesive resin include amino-containing polyamide (PA) resins and thermoplastic epoxy-containing styrene elastomers. These adhesive resins may be used either alone or in combination. A blend of a PBN, a polybutylene terephthalate (PBT), a thermoplastic PBN elastomer and/or a thermoplastic PBT elastomer may be employed as the adhesive resin.

The adhesive resin preferably has a flexural modulus of 200 to 1600 MPa, particularly preferably 300 to 1000 MPa, to allow the entire hose to have sufficient flexibility.

For formation of the adhesive layer of the inventive automotive fuel hose shown in FIG. 3, the outer peripheral surface 1a of the inner layer 1 is plasma-treated in the same manner as described with reference to FIG. 2, and then the adhesive resin is extruded on the plasma-treated surface 1a by means of an extruder. Subsequently, the low permeability layer 2 is formed on the outer peripheral surface of the adhesive layer 3 by extruding the PBN in the aforesaid manner.

The adhesive layer 3 preferably has a thickness of 0.02 to 0.8 mm, particularly preferably 0.05 to 0.6 mm.

The structure of the inventive automotive fuel hose is not limited to those shown in FIGS. 1 and 3, but an outer layer may be provided on the outer peripheral surface of the low permeability layer 2 in consideration of flame resistance, chipping resistance, shock resistance, weather resistance, kinking resistance, bending formability and connector press-fitting property.

The material for the outer layer is not particularly limited, but examples thereof include polyamide resins, a thermoplastic ester elastomer (TPEE), a thermoplastic polyamide elastomer (TPAE), a thermoplastic polyolefin elastomer (TPO) and a thermoplastic polystyrene elastomer (TPS) as described above. The outer layer typically has a thickness of 0.3 to 1.5 mm, preferably 0.5 to 1.0 mm. The structure of the outer layer is not limited to a single-layer structure, but may be a multi-layer structure consisting of two or more sublayers.

Next, an explanation will be given to examples and comparative examples.

Prior to the explanation of the examples and the comparative examples, ingredients employed in these examples will be described below.

Electrically Conductive ETFE

An electrically conductive ethylene-tetrafluoroethylene copolymer (ETFE) prepared by blending 15 wt % of electrically conductive carbon black (KETJEN EC available from Ketjen Black International Corporation) in an ethylene-tetrafluoroethylene copolymer.

Electrically Conductive PE

An electrically conductive polyethylene (PE) prepared by blending 7 wt % of electrically conductive carbon black (KETJEN EC available from Ketjen Black International Corporation) in a polyethylene.

Adhesive Resin (a)

An amino-containing PA12 (flexural modulus: 520 MPa).

Adhesive Resin (b)

A mixture obtained by blending a thermoplastic PBT elastomer and an amino-containing PA12 in a weight ratio of 70:30 (flexural modulus: 500 MPa).

Adhesive Resin (c)

A thermoplastic epoxy-containing styrene elastomer (flexural modulus: 200 MPa).

Adhesive Resin (d)

A mixture obtained by blending a thermoplastic PBT elastomer and a thermoplastic epoxy-containing styrene elastomer in a weight ratio of 70:30 (flexural modulus: 400MPa).

PBN

A condensation product of tetramethylene glycol and 2,6-naphthalenedicarboxylic acid (viscosity: 140 cm³/g)

PBN (1)

A PBN modified by causing hexamethylenediamine to react with a melt of a condensation product of tetramethylene glycol and 2,6-naphthalenedicarboxylic acid (viscosity: 140 cm³/g).

PBN (2)

A PBN modified by causing m-xylylenediamine to react with a melt of a condensation product of tetramethylene glycol and 2,6-naphthalenedicarboxylic acid (viscosity: 142 cm³/g).

PBN (3)

A PBN modified by causing a solution of N-(2-aminoethyl)-3-aminopropyltrimethoxysilane to react with particles (having an average particle diameter of 40 μm) of a melt of a condensation product of tetramethylene glycol and 2,6-naphthaienedicarboxylic acid (viscosity: 141 cm³/g).

PBN (4)

A PBN modified by causing a solution of N-(2-aminoethyl)-3-aminopropyltriethoxysilane to react with particles (having an average particle diameter of 40 μm) of a melt of a condensation product of tetramethylene glycol and 2,6-naphthalenedicarboxylic acid (viscosity: 141 cm³/g)

PBN (5)

A PBN modified by causing a solution of 3-glycidoxypropyltrimethoxysilane to react with particles (having an average particle diameter of 90 μm) of a melt of a condensation product of tetramethylene glycol and 2,6-naphthalenedicarboxylic acid (viscosity: 140 cm³/g).

PBN (6)

A PBN modified by causing a solution of vinyltriethoxysilane to react with particles (having an average particle diameter of 70 μm) of a melt of a condensation product of tetramethylene glycol and 2,6-naphthalenedicarboxylic acid (viscosity: 140 cm³/g).

TPEE

A thermoplastic PBT elastomer.

AD (1)

A mixture obtained by blending an ETFE, a PBN and ethyleneglycidyl methacrylate in a weight ratio of 5:5:1.

AD (2)

A mixture obtained by blending a PA12, a PBN and a thermoplastic polyurethane in a weight ratio of 4:4:1.

### EXAMPLE 1

An inner layer was formed by extruding ETFE into a sizing water vessel at a reduced pressure by means of an extruder in the same manner as shown in FIG. 2. After an outer peripheral surface of the inner layer was subjected to a reduced pressure plasma treatment, PBN was extruded on the plasma-treated surface by means of an extruder, whereby a low permeability PBN layer was formed on the plasma-treated surface of the inner layer. Thus, a fuel hose was produced which has an inner diameter of 6mm and an outer diameter of 8 mm. The plasma treatment was performed at a frequency of 13.56 MHz at an output of 250 W after a reaction chamber was evacuated to a pressure of 0.13 Pa by a vacuum pump and an Ar-containing gas was supplied into the reaction vessel at a pressure of 9.3 Pa from a gas feeding device.

### EXAMPLES 2 to 17

Fuel hoses were produced in substantially the same manner as in Example 1, except that inner layer materials, low permeability layer materials and outer layer materials shown in Tables 1 to 3 were employed.

### EXAMPLES 18 to 29

Fuel hoses were produced in substantially the same manner as in Example 1, except that adhesive layers were each formed between the inner layer and the low permeability layer by employing adhesive resins shown in Tables 4 and 5.

### Comparative Examples 1 and 2

Fuel hoses were produced by simultaneously extruding materials shown in Table 6 by means of five extruders and combining the resulting layers by means of a die. The plasma treatment on an outer peripheral surface of an inner layer was not performed before formation of an adhesive layer and a resin layer.

### Comparative Example 3

A fuel hose was produced in substantially the same manner as in Example 3, except that a corona treatment was performed instead of the plasma treatment. The corona treatment was performed at a frequency of 20 kHz at an output of 0.4 kw in the atmosphere.

### Comparative Example 4

A fuel hose was produced in substantially the same manner as in Comparative Example 3, except that an adhesive layer was formed.

The properties of the fuel hoses of the examples and the comparative examples were evaluated in the following manner. The results are shown in Tables 1 to 6.

Permeability

The fuel hoses were each cut to a length of 500 mm. After a fuel (prepared by blending 10 vol % of ethanol in gasoline (Fuel C)) was filled in the fuel hose, opposite ends of the fuel hose were capped. The resulting hose was allowed to stand still in an oven at 40° C. for 40 days, and permeability (mg/m/day) was determined on the basis of a reduction in the weight of the entire hose per day.

Sour Gasoline Resistance

A mixture was prepared by blending 5 wt % of laurylperoxide in Fuel C. The mixture was circulated in each of the fuel hoses at 60° C. for 360 hours. Then, the fuel hose was bent, and the inner layer was visually inspected for evaluation of the sour gasoline resistance. In Tables 1 to 6, a symbol X indicates that the inner layer was cracked, and a symbol ◯ indicates that no cracking was observed on the inner layer.

Peel Force

The fuel hoses were each longitudinally cut into four strips. By using one of the strips, a peel force (N/cm) required for separating the inner layer from the low permeability layer was determined. After the fuel hoses were each filled with a fuel (prepared by blending 10 vol % of ethanol in Fuel C) and allowed to stand still at 60° C. for one week, a peel force (N/cm) required for separating the inner layer from the low permeability layer was determined in the same manner as described above.

TABLE 1

| | Example | | | | | |
|---|---|---|---|---|---|---|
| | 1 | 2 | 3 | 4 | 5 | 6 |
| Inner layer | | | | | | |
| Inner sublayer | ETFE | C-ETFE* | C-ETFE* | C-ETFE* | C-ETFE* | C-ETFE* |
| Outer sublayer | | ETFE | ETFE | ETFE | ETFE | ETFE |
| Surface treatment | Plasma | Plasma | Plasma | Plasma | Plasma | Plasma |
| | treatment | treatment | treatment | treatment | treatment | treatment |
| Adhesive layer | — | — | — | — | — | — |
| Low permeability layer | PBN | PBN | PBN | PBN | PBN(1) | PBN(2) |
| Outer layer | | | | | | |
| Inner sublayer | — | — | TPEE | AD(1) | AD(1) | TPEE |
| Outer sublayer | | | | PA12 | PA12 | |
| Thickness | | | | | | |
| Inner layer | | | | | | |
| Inner sublayer | 0.3 | 0.1 | 0.1 | 0.1 | 0.1 | 0.1 |
| Outer sublayer | | 0.2 | 0.1 | 0.1 | 0.1 | 0.1 |
| Adhesive layer | — | — | — | — | — | — |
| Low permeability layer | 0.7 | 0.7 | 0.2 | 0.2 | 0.2 | 0.2 |
| Outer layer | | | | | | |
| Inner sublayer | — | — | 0.6 | 0.1 | 0.1 | 0.6 |
| Outer sublayer | | | | 0.5 | 0.5 | |
| Surface electrical resistance (Ω) | — | 1.2 × 10³ | | | | |
| of conductive inner sublayer | | | | | | |
| Permeability (mg/m/day) | 0.9 | 1.1 | 3.1 | 3.0 | 3.1 | 3.1 |
| Sour gasoline resistance | ◯ | ◯ | ◯ | ◯ | ◯ | ◯ |
| Peel force (N/cm) | | | | | | |
| Initial | 23 | 23 | 24 | 23 | 28 | 26 |
| After filled with fuel | 18 | 18 | 17 | 18 | 22 | 22 |

C-ETFE*: Conductive ETFE

TABLE 2

| | Example | | | | | |
|---|---|---|---|---|---|---|
| | 7 | 8 | 9 | 10 | 11 | 12 |
| Inner layer | | | | | | |
| Inner sublayer | C-ETFE | C-ETFE* | C-ETFE* | C-ETFE* | PE | C-PE* |
| Outer sublayer | ETFE | ETFE | ETFE | ETFE | | PE |
| Surface treatment | Plasma | Plasma | Plasma | Plasma | Plasma | Plasma |
| | treatment | treatment | treatment | treatment | treatment | treatment |
| Adhesive layer | — | — | — | — | — | — |
| Low permeability layer | PBN(3) | PBN(4) | PBN(5) | PBN(6) | PBN | PBN |
| Outer Layer | | | | | | |
| Inner sublayer | TPEE | TPEE | TPEE | TPEE | — | — |
| Outer sublayer | | | | | | |
| Thickness | | | | | | |
| Inner layer | | | | | | |
| Inner sublayer | 0.1 | 0.1 | 0.1 | 0.1 | 0.3 | 0.1 |
| Outer sublayer | 0.1 | 0.1 | 0.1 | 0.1 | | 0.2 |
| Adhesive layer | — | — | — | — | — | — |
| Low permeability layer | 0.2 | 0.2 | 0.2 | 0.2 | 0.7 | 0.7 |
| Outer layer | | | | | | |
| Inner sublayer | 0.6 | 0.6 | 0.6 | 0.6 | — | — |
| Outer sublayer | | | | | | |
| Surface electrical resistance (Ω) | 1.2 × 10³ | | | | — | 1.5 × 10³ |
| of conductive inner sublayer | | | | | | |
| Permeability (mg/m/day) | 3.2 | 3.1 | 3.1 | 3.1 | 1.0 | 1.1 |
| Sour gasoline resistance | ◯ | ◯ | ◯ | ◯ | ◯ | ◯ |
| Peel force (N/cm) | | | | | | |
| Initial | 28 | 29 | 27 | 26 | 22 | 22 |
| After filled with fuel | 23 | 23 | 22 | 22 | 18 | 18 |

C-ETFE*: Conductive ETFE
C-PE*: Conductive PE

TABLE 3

| | Example | | | | |
|---|---|---|---|---|---|
| | 13 | 14 | 15 | 16 | 17 |
| Inner layer | | | | | |
| Inner sublayer | C-PE* | C-PE* | C-PE* | C-PE* | C-PE* |
| Outer sublayer | PE | PE | PE | PE | PE |
| Surface treatment | Plasma | Plasma | Plasma | Plasma | Plasma |
| | treatment | treatment | treatment | treatment | treatment |
| Adhesive layer | — | — | — | — | — |
| Low permeability layer | PBN | PBN | PBN(1) | PBN(3) | PBN(5) |
| Outer layer | | | | | |
| Inner sublayer | TPEE | AD(1) | AD(1) | TPEE | TPEE |
| Outer sublayer | | PA12 | PA12 | | |
| Thickness | | | | | |
| Inner layer | | | | | |
| Inner sublayer | 0.1 | 0.1 | 0.1 | 0.1 | 0.1 |
| Outer sublayer | 0.1 | 0.1 | 0.1 | 0.1 | 0.1 |
| Adhesive layer | — | — | — | — | — |
| Low permeability layer | 0.2 | 0.2 | 0.2 | 0.2 | 0.2 |
| Outer layer | | | | | |
| Inner sublayer | 0.6 | 0.1 | 0.1 | 0.6 | 0.6 |
| Outer sublayer | | 0.5 | 0.5 | | |
| Surface electrical resistance (Ω) | 1.5 × 10³ | | | | |
| of conductive inner sublayer | | | | | |
| Permeability (mg/m/day) | 3.1 | 3.1 | 3.2 | 3.2 | 3.2 |
| Sour gasoline resistance | ◯ | ◯ | ◯ | ◯ | ◯ |
| Peel force N/cm | | | | | |
| Initial | 21 | 22 | 27 | 26 | 25 |
| After filled with fuel | 18 | 17 | 22 | 22 | 22 |

C-PE*: Conductive PE

TABLE 4

| | Example | | | | | |
|---|---|---|---|---|---|---|
| | 18 | 19 | 20 | 21 | 22 | 23 |
| Inner layer | | | | | | |
| Inner sublayer | ETFE | C-ETFE* | C-ETFE* | C-ETFE* | C-ETFE* | C-ETFE* |
| Outer sublayer | | ETFE | ETFE | ETFE | ETFE | ETFE |
| Surface treatment | Plasma | Plasma | Plasma | Plasma | Plasma | Plasma |
| | treatment | treatment | treatment | treatment | treatment | treatment |
| Adhesive Layer | (a) | (a) | (a) | (a) | (b) | (c) |
| Low permeability layer | PBN | PBN | PBN | PBN | PBN | PBN |
| Outer layer | | | | | | |
| Inner sublayer | — | — | TPEE | AD(1) | TPEE | TPEE |
| Outer sublayer | | | | PA12 | | |
| Thickness | | | | | | |
| Inner layer | | | | | | |
| Inner sublayer | 0.3 | 0.1 | 0.1 | 0.1 | 0.1 | 0.1 |
| Outer sublayer | | 0.2 | 0.1 | 0.1 | 0.1 | 0.1 |
| Adhesive layer | 0.1 | 0.1 | 0.1 | 0.1 | 0.1 | 0.1 |
| Low permeability layer | 0.6 | 0.6 | 0.2 | 0.2 | 0.2 | 0.2 |
| Outer layer | | | | | | |
| Inner sublayer | — | — | 0.6 | 0.1 | 0.6 | 0.6 |
| Outer sublayer | | | | 0.5 | | |
| Surface electrical resistance (Ω) | — | 1.2 × 10³ | | | | |
| of conductive inner sublayer | | | | | | |
| Permeability (mg/m/day) | 1 | 1.1 | 3.1 | 3.1 | 3.1 | 3.1 |
| Sour gasoline resistance | ◯ | ◯ | ◯ | ◯ | ◯ | ◯ |
| Peel force (N/cm) | | | | | | |
| Initial | 29 | 30 | 30 | 31 | 28 | 31 |
| After filled with fuel | 20 | 19 | 20 | 20 | 22 | 22 |

C-ETFE*: Conductive ETFE

TABLE 5

| | Example | | | | | |
|---|---|---|---|---|---|---|
| | 24 | 25 | 26 | 27 | 28 | 29 |
| Inner layer | | | | | | |
| Inner sublayer | C-ETFE* | C-PE* | C-PE* | C-PE* | C-PE* | C-PE* |
| Outer sublayer | ETFE | PE | PE | PE | PE | PE |
| Surface treatment | Plasma | Plasma | Plasma | Plasma | Plasma | Plasma |
| | treatment | treatment | treatment | treatment | treatment | treatment |
| Adhesive layer | (c) | (a) | (a) | (b) | (c) | (d) |
| Low permeability layer | PBN | PBN | PBN | PBN | PBN | PBN |
| Outer layer | | | | | | |
| Inner sublayer | TPEE | TPEE | AD(1) | TPEE | TPEE | TPEE |
| Outer sublayer | | | PA12 | | | |
| Thickness | | | | | | |
| Inner layer | | | | | | |
| Inner sublayer | 0.1 | 0.1 | 0.1 | 0.1 | 0.1 | 0.1 |
| Outer sublayer | 0.1 | 0.1 | 0.1 | 0.1 | 0.1 | 0.1 |
| Adhesive layer | 0.1 | 0.1 | 0.1 | 0.1 | 0.1 | 0.1 |
| Low permeability layer | 0.2 | 0.2 | 0.2 | 0.2 | 0.2 | 0.2 |
| Outer layer | | | | | | |
| Inner sublayer | 0.6 | 0.6 | 0.1 | 0.6 | 0.6 | 0.6 |
| Outer sublayer | | | 0.5 | | | |
| Surface electrical resistance (Ω) | 1.2 × 10³ | 1.5 × 10³ | | | | |
| of conductive inner sublayer | | | | | | |
| Permeability (mg/m/day) | 3.2 | 3.3 | 3.2 | 3.2 | 3.3 | 3.3 |
| Sour gasoline resistance | ◯ | ◯ | ◯ | ◯ | ◯ | ◯ |
| Peel force (N/cm) | | | | | | |
| Initial | 29 | 28 | 28 | 29 | 32 | 30 |
| After filled with fuel | 24 | 22 | 21 | 21 | 22 | 22 |

C-ETFE*: Conductive ETFE
C-PE*: Conductive PE

TABLE 6

| | Comparative Example | | | |
|---|---|---|---|---|
| | 1 | 2 | 3 | 4 |
| Inner layer | | | | |
| Inner sublayer | ETFE | PA12 | C-ETFE* | C-ETFE* |
| Outer sublayer | AD(1) | AD(2) | ETFE | ETFE |
| Surface treatment | — | — | Corona | Corona |
| | | | treatment | treatment |
| Adhesive layer | — | — | — | (a) |
| Low permeability layer | PBN | PBN | PBN | PBN |
| Outer layer | | | | |
| Inner sublayer | AD(2) | AD(2) | TPEE | TPEE |
| Outer sublayer | PA12 | PA12 | | |
| Thickness | | | | |
| Inner layer | | | | |
| Inner sublayer | 0.2 | 0.2 | 0.1 | 0.1 |
| Outer sublayer | 0.1 | 0.1 | 0.1 | 0.1 |
| Adhesive layer | — | — | — | 0.1 |
| Low permeability layer | 0.2 | 0.2 | 0.2 | 0.2 |
| Outer layer | | | | |
| Inner sublayer | 0.1 | 0.1 | 0.6 | 0.6 |
| Outer sublayer | 0.5 | 0.5 | | |
| Surface electrical resistance (Ω) | — | — | 1.2 × 10³ | |
| of conductive inner sublayer | | | | |
| Permeability (mg/m/day) | 3.3 | 3.9 | 3.5 | 3.5 |
| Sour gasoline resistance | ◯ | x | ◯ | ◯ |
| Peel force (N/cm) | | | | |
| Initial | 6 | 12 | 4 | 5 |
| After filled with fuel | 3 | 10 | 2 | 3 |

C-ETFE*: Conductive ETFE

As can be understood from the results, the fuel hoses of the examples were excellent in permeation resistance, sour gasoline resistance and adhesion.

On the other hand, the fuel hose of Comparative Example 1, whose inner layer was not subjected to the plasma treatment, was inferior in adhesion between the inner layer and the low permeability layer. The fuel hose of Comparative Example 2, whose inner layer was composed of the polyamide resin and was not subjected to the plasma treatment, was inferior in sour gasoline resistance and adhesion between the inner layer and the low permeability layer. The fuel hoses of Comparative Examples 3 and 4, whose inner layers were not subjected to the plasma treatment but to the corona treatment, were each insufficient in adhesion between the inner layer and the low permeability layer, because the corona treatment was less effective in surface modification of the inner layer than the plasma treatment.

As described above, the outer peripheral surface of the inner layer of the inventive automotive fuel hose is plasma-treated. Therefore, the fluororesin or the polyolefin resin is modified, so that hydroxyl groups are generated on the surface of the inner layer and interact with terminal carboxyl groups of the polybutylene naphthalate. Thus, the adhesion between the inner layer and the low permeability layer is improved. Particularly, the polybutylene naphthalate has a high melting point. Therefore, the polybutylene naphthalate can be extruded at a higher temperature, so that the interaction between the hydroxyl groups and the carboxyl groups is enhanced. In addition, the inner layer of the inventive automotive fuel hose to be brought into contact with the fuel is composed of the fluororesin or the polyolefin resin which is excellent in sour gasoline resistance, and the low permeability layer provided on the outer peripheral surface of the inner layer is composed of the polybutylene naphthalate which is excellent in permeability resistance. Therefore, the inventive automotive fuel hose satisfies the low permeability requirements in conformity with the stringent regulations against the vapor emission of hydrocarbons and alcohol-containing hydrocarbons, and is less permeable to hydrogen and excellent in sour gasoline resistance and inter-layer adhesion.

Where the adhesive layer of the specific adhesive resin is provided between the inner layer and the low permeability layer, the adhesion between the inner layer and the low permeability layer is further improved.

Where the polybutylene naphthalate is modified by terminating the terminal groups of the polybutylene naphthalate with the compound having the specific functional group (e.g., amino group), the adhesion between the inner layer and the low permeability layer is further improved. Where the silane compound having an amino group and an alkoxy group is employed as the compound having the specific functional group, for example, the alkoxy group of the silane compound reacts with the polybutylene naphthalate, and the amino group (functional group) of the silane compound reacts with the plasma-treated surface. Thus, the adhesion between the inner layer and the low permeability layer is further improved.

Where the inner layer includes at least one electrically conductive sublayer having a surface electrical resistance of not higher than 10⁶Ω, static electricity generated by a fuel pump can efficiently be released through the electrically conductive sublayer. Thus, an accident such as ignition of the fuel (e.g., gasoline) can effectively be prevented which may otherwise be caused by the static electricity.

What is claimed is:

1. An automotive fuel hose comprising: an inner layer comprising one of a fluororesin and a polyolefin resin; and a low permeability layer comprising a polybutylene naphthalate; the inner layer having a plasma-treated outer peripheral surface; the low permeability layer being provided on the plasma-treated surface of the inner layer.

2. An automotive fuel hose as set forth in claim 1, wherein an adhesive layer of an adhesive resin containing at least one of an amino group and an epoxy group is provided between the inner layer and the low permeability layer.

3. An automotive fuel hose as set forth in claim 1, wherein the polybutylene naphthalate is a modified polybutylene naphthalate having a terminal group terminated with at least one compound selected from the group consisting of a diamine compound, an amino-containing compound, an epoxy-containing compound and a double-bond-containing silane compound.

4. An automotive fuel hose as set forth in claim 2, wherein the polybutylene naphthalate is a modified polybutylene naphthalate having a terminal group terminated with at least one compound selected from the group consisting of a diamine compound, an amino-containing compound, an epoxy-containing compound and a double-bond-containing silane compound.

5. An automotive fuel hose as set forth in claim 1, wherein the inner layer is an electrically conductive layer having a surface electrical resistance of not higher than 10⁶Ω.

6. An automotive fuel hose as set forth in claim 1, wherein the inner layer has a multi-layer structure which includes at least one electrically conductive sublayer having a surface electrical resistance of not higher than 10⁶Ω.
